(19) United States
(12) Patent Application Publication
(10) Pub. No.: US 2015/0120766 A1
(43) Pub. Date: Apr. 30, 2015

(54) Method and Apparatus for Delivering Search Results

(71) Applicant: TWOFOLD IP PTY LTD, Taringa (AU)

(72) Inventors: Robin James Hamilton, Taringa (AU); Guy Andrew Hamilton, Taringa (AU)

(21) Appl. No.: 14/519,366

(22) Filed: Oct. 21, 2014

(30) Foreign Application Priority Data
Oct. 30, 2013 (AU) 2013904193

(51) Int. Cl. G06F 17/30; G06F 17/27

(52) U.S. Cl. CPC G06F 17/30699; G06F 17/2705; G06F 17/30091; G06F 17/30241
USPC 707/754; 707/755

(57) ABSTRACT

The method involves aggregating post text, information about the type of content that has been posted, the post's creation time (time stamp), geographical origin (geo tag) and the username and storing it in a database. In order to search content that has been stored a web-server prompts clients for their search terms which it then parses. The webserver is programmed to identify portions of the search terms as corresponding to locations, hashtags or general search keywords. The method then involves interrogating the database to return relevant results from the vast array of social media content. The results are initially presented back to clients as links comprising markers on a map described on the screen of the client's device. The client can scroll the map view in order to also see the results in a list format. The client can then refine the results according to a number of filters.

### TECHNICAL FIELD

The present invention relates to search engines for aggregating media content.

### BACKGROUND

Any references to methods, apparatus or documents of the prior art are not to be taken as constituting any evidence or admission that they formed, or form part of the common general knowledge.

The use of Internet search engines such as Google, Bing and Yahoo etc. has become well known over the past fifteen years. Each of these search engines search information that is available on the Internet and deliver search results to clients in response to client search queries.

Typically the searches that are performed entail sifting through vast numbers of webpages that are continually, though relatively slowly, in the process of change.

The search results are then typically provided as lists of brief extracts or abstracts from the webpages that are deemed to best match the client's search query. The client can then scan through the list to find a result of interest and then click on a hyperlink in the search results so that the client's web-browser then displays the webpage of interest.

Most information that is available on the Internet via search engines, and for that matter through other information sources such as television, is censored, curated and biased from the searcher's perspective. Social media has acted to break down censorship by providing the searcher with information about a particular person or topic as it occurs at a specific time and location.

For people that are particularly interested in understanding new social trends or detecting emerging demographic behavior patterns quickly, the results that are provided by current search engines can sometimes be disappointing because they are often not as up to date as might be desired.

Furthermore, in order to observe an emerging trend a client may have to perform numerous different searches and then process the results. For example, if a client is interested in how popular a certain sporting team is in different parts of the country, or in different parts of the world, then the client will probably need to perform numerous searches and analyse the results that are returned. Such a process is of course time-consuming and tedious.

It is an object of the present invention to at least partially overcome or ameliorate one or more of the disadvantages of the prior art, or to provide a useful alternative.

### SUMMARY OF THE INVENTION

According to a first aspect of the present invention there is provided a method for returning search results to a client computational device including the steps of: storing the content of social media posts in a database wherein the social media posts are searchable by at least geotags, timestamps and post text; processing a search query from a remote client by parsing the search query for at least search keywords, a specified geographical location and a specified time frame; operating a database server in communication with the database to return search results therefrom corresponding to the search query; and serving the search results to a browser running on the client computational device.

The search results may be presented as points on a map wherein the points are presented at the specified geographical location.

Preferably the method further includes a step of reducing a popularity variable in the event that the number of returned search results does not comprise a full set of results.

The search results may be presented as lists of results.

In a preferred embodiment of the invention the method includes presenting the user with a number of options for sorting search results.

Preferably the method includes presenting the user with one or more options for ordering search results.

Preferably the step of presenting the search results includes presenting the search results to graphically indicate the latest search results.

The step of presenting the search results may also include presenting the search results to graphically indicate trends in the search results.

The step of presenting the search results may include sorting the search results to show the most popular results.

Preferably the method comprises continuously updating the store of social media posts and presenting updated search results to the remote client as new posts meeting the remote client's search query are encountered.

In a preferred embodiment of the invention the method includes presenting the remote client with options to refine the search query according to a number of filters.

The filters may include content type, timeframe in which posts were created and geographic location.

Additional features and advantages of the present invention are described in, and will be apparent from, the detailed description of the presently preferred embodiments and from the drawings.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a block diagram illustrating a system for implementation of a method according to a preferred embodiment of the present invention.

FIGS. 2 to 7 comprise a flowchart of a method according to a preferred embodiment of the present invention.

FIGS. 8 to 13 are screen shots of webpages generated on a client's browser during implementation of an example of the operation of the method.

FIGS. 14 to 17 are screen shots of webpages generated on a client's browser illustrating a trending display functionality of the method.

### DETAILED DESCRIPTION

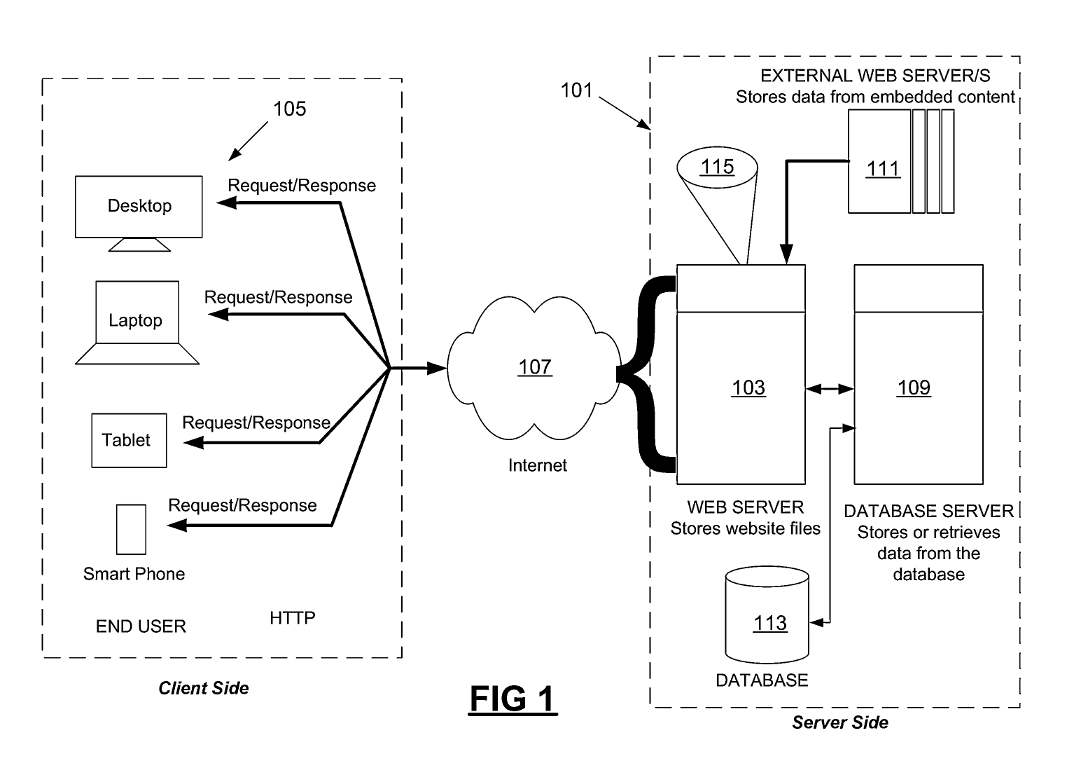

FIG. 1 depicts a system 101 for performance of a method according to a preferred embodiment of the invention that will shortly be described. The system 101 include a webserver 103 that is data communication with client devices 105 via the internet 107. The webserver 103 is programmed according to a software product 115 which is comprised of machine readable instructions for the webserver to implement a method according to a preferred embodiment of the present invention that will be explained. The webserver 103 also communicates with a database server 109 and with external webserver 111. The database server 109 stores and retrieves data from database 113.

The external webserver(s) 111 stores embedded data from external sources such as images, video streams, audio streams, HTML code and text content from webpages.

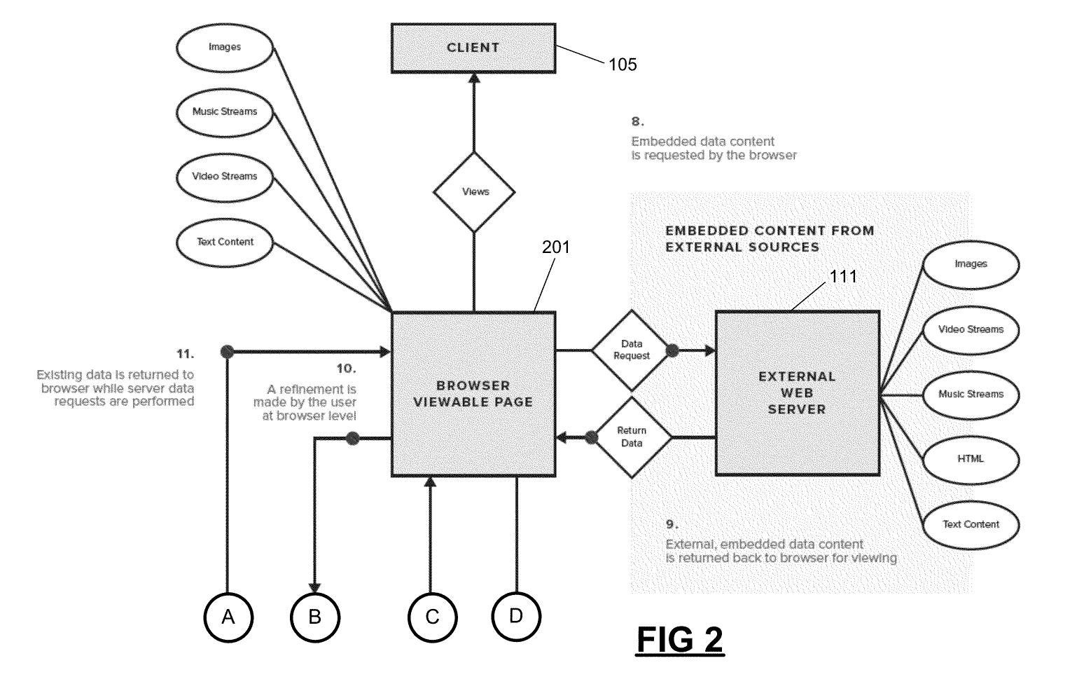

FIGS. 2 to 7 comprise a flowchart of a method according to a preferred embodiment of the present invention. This method uses social media content to perform client searches in order to return uncensored, live, real-time information throughout the world. As will be seen, the method uses social media geo-tagging, for example the geotags of posts to discover social media activity at precise geographic locations. The method also uses social media time stamps and geo-tags to pinpoint activity about past events in time and, by also searching for viewing/sharing activity is able to plot trends over time.

One example of a conduit for social networking posts is Twitter, which assists users in making posts or “tweets”. While the system that will be described is particularly suited to working in conjunction with Twitter it may also be used otherwise. For example, it may be configured to “scrape” (a term for constantly pulling data) and aggregate publicly available data from social media sources like Facebook, Twitter and Google+.

The method functions by aggregating all available social media content. In the present description the social media content will typically comprise short social media posts such as the “tweets” that are generated by social media company Twitter in response to their users' inputs. The method involves aggregating post text, information about the type of content that has been posted, the post's creation time (time stamp), geographical origin (geo tag) and the username and storing it in database 113.

In order to search the content that has been stored the web-server 103 prompts clients 105 for their search terms which it then parses. The webserver 103 is programmed to identify portions of the search terms as corresponding to locations, hashtags or general search keywords. The method then involves interrogating the database 113 to return relevant results from the vast array of social media content. The results are initially presented back to clients 105 as links comprising markers on a map described on the screen of the client's device. The client can scroll the map view in order to also see the results in a list format. The client can then refine the results according to a number of filters such as content type, the timeframe in which they were posted and their geographic location. The client can also sort the results in order of “latest”, “trending”, “most popular” and “geographical proximity”. If a list item is selected then the other results will fade out and the selected list item's geographical location is presented pinpointed on the map displayed on the user's client device.

The method also provides the user with options to search for specific content or alternatively to browse content on the map by zooming and panning for search result links described thereon.

Content Refinements

Results are able to be searched, refined and sorted at any time using the variables below:

TABLE 1

| Search | Search Term |
|---|---|
| Sort | Latest, trending, most popular, closest geographically |
| Content Type | Texts, photos, videos, audio, hashtags, users, locations |
| Time | Past X Minutes/Hours, Date set from-to |
| Location | The World, Country, State, City, Specific Location |
| | Marker |

The data processing and transfer process of the preferred method will now be described in the following seven steps which are written in pseudo code.

Step 1.
On initial page request—onLoad
Set initial refinements to pull most popular results
Server receives call for data Algorithm function to request relevant data
SET geoLocation to be worldwide
SET hashTag to null
SET Term to null
SET userName to null
SET Location to null
SET Time to Latest (x minutes)
SET Sort to mostPopular
CALL dataAlgorithm

Step 2.
On refinement being set—dataRequest
Receive refinement inputs from user
Call for dataAlgorithm function to request relevant data

```
IF geoLocation is defined by the user THEN
  SET geoLocation to userDefined
  CALL dataAlgorithm
END IF
IF hashTag is defined by the user THEN
  SET hashTag to userDefined
  CALL dataAlgorithm
END IF
IF Term is defined by the user THEN
  SET Term to userDefined
  CALL dataAlgorithm
END IF
IF userName is defined by the user THEN
  SET userName to userDefined
  CALL dataAlgorithm
END IF
IF Location is defined by the user THEN
  SET Location to userDefined
  CALL dataAlgorithm
END IF
IF Time is defined by the user THEN
  SET Time to userDefined
  CALL dataAlgorithm
END IF
IF Sort is defined by the user THEN
  SET Sort to userDefined
  CALL dataAlgorithm
END IF
```

Step 3. Data is requested from the server—dataAlgorithm. User refinements are set for dataAlgorithm function. The server receives a call for data. Data is run through checkpoint to ensure that there are enough results. If insufficient results are returned then the time variable is decremented and run through the algorithm again. Once enough results are returned, the data is stored for sorting function.

SET geoLocation to be userDefined

SET hashTag to be userDefined

SET Term to be userDefined

SET userName to userDefined

SET Location to userDefined

SET Time to userDefined

SET Sort to userDefined

```
//Call data from the server
Call Data
//If the data algorithm returns less than a full set of results
IF dataResults is < Full THEN
//Reduce Popularity variable using Time variable
  IF Time > 0 THEN
    DECREMENT Time
    CALL DATA
END IF
END IF
STORE Data in dataResults
END dataAlgorithm
```

Step 4. Data is sorted for site viewing—dataSort. Server receives call for data. geoLocation is read from social media content and geoPosition is calculated to place content on the map. Sorting variables are read from the website along with data to calculate the order position of the content. Content is sorted, ordered and returned to website server.

CALL Data from the server

READ geoLocation from Social Media content

FOR each Data Set (individual Social Media content)

COMPUTE geoPosition
//geoPosition = geoLocation at map screen view
STORE geoPosition in Result (Data Set)
End FOR

READ Sort, shareCount, viewCount, friendCount and Time variables from Social Media content

```
IF Sort = Latest THEN
  FOR each Data Set (individual Social Media content)
  COMPUTE orderPosition
  //orderPosition = Time latest
  STORE orderPosition in Result (Data Set)
  End FOR
END IF
IF Sort = mostPopular THEN
FOR each Data Set (individual Social Media content)
  COMPUTE orderPosition
  //orderPosition = ((shareCount+viewCount)/friendCount)/Time
  STORE orderPosition in Result (Data Set)
  End FOR
END IF
IF Sort = Trending THEN
  FOR each Data Set (individual Social Media content)
  COMPUTE orderPosition
  //orderPosition=(shareCount+viewCount)/(Time/trendingInteger)
  STORE orderPosition in Result (Data Set)
  End FOR
END IF
IF Sort = Closest THEN
  FOR each Data Set (individual Social Media content)
  COMPUTE orderPosition
  //orderPosition = closest to tagged geoLocation
  STORE orderPosition in Result (Data Set)
  End FOR
END IF
STORE Data to be returned to website
END
```

STEP 5.

Data is returned to browser viewable web page—dataReturn

Server pushes data to web page

STEP 6.

Listen for new data—dataListen

Server listens for new data

```
IF timeElapsed = timeInterval THEN
  CALL dataAlgorithm function
  CALL dataSort function
  CALL dataPush function
END IF
```

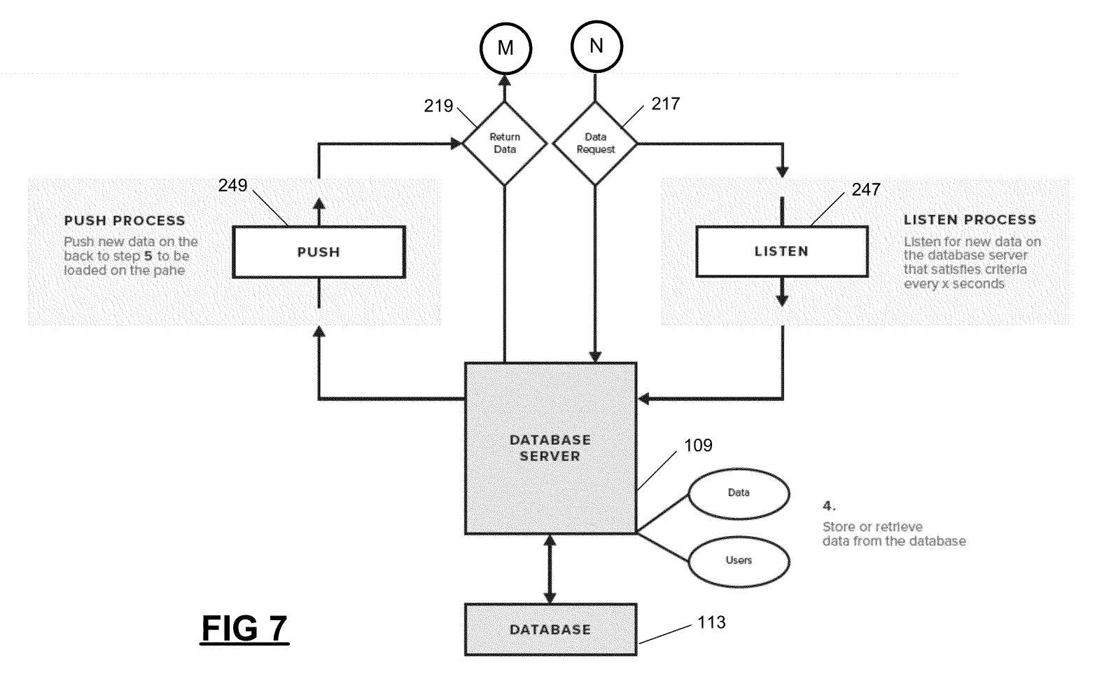

STEP 7. (FIG. 7)

Push new data to site—dataPush

Server pushes relevant new data to site

STORE new Data as dataNEW

COMPUTE Total number of new results

FOR each existing Data Set in dataResults

orderPosition=orderPosition+Total

END FOR

APPEND dataNew to dataResults

STORE Data in dataResults

END

FIGS. 2 to 7 comprise a flowchart of the method according to a preferred embodiment of the present invention.

Referring now to FIG. 2, initially a client, e.g. a human operating an Internet connected computational device 105 establishes a connection with webserver 103 by browsing to a web interface facilitated by the webserver i.e. a browser viewable webpage at box 201.

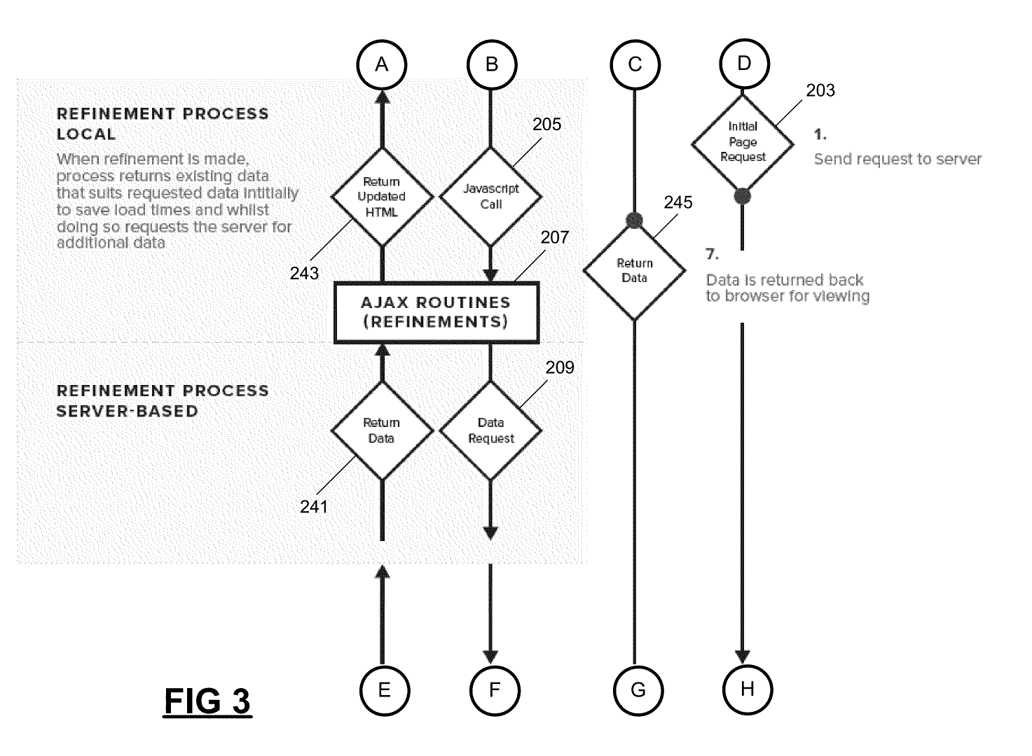

Upon the client device 105 contacting the webserver an intial page request (box 203, FIG. 3) is sent to the webserver 103. This involves the onLoad routine being called which is documented in the Step 1 pseudo code that has been previously set out.

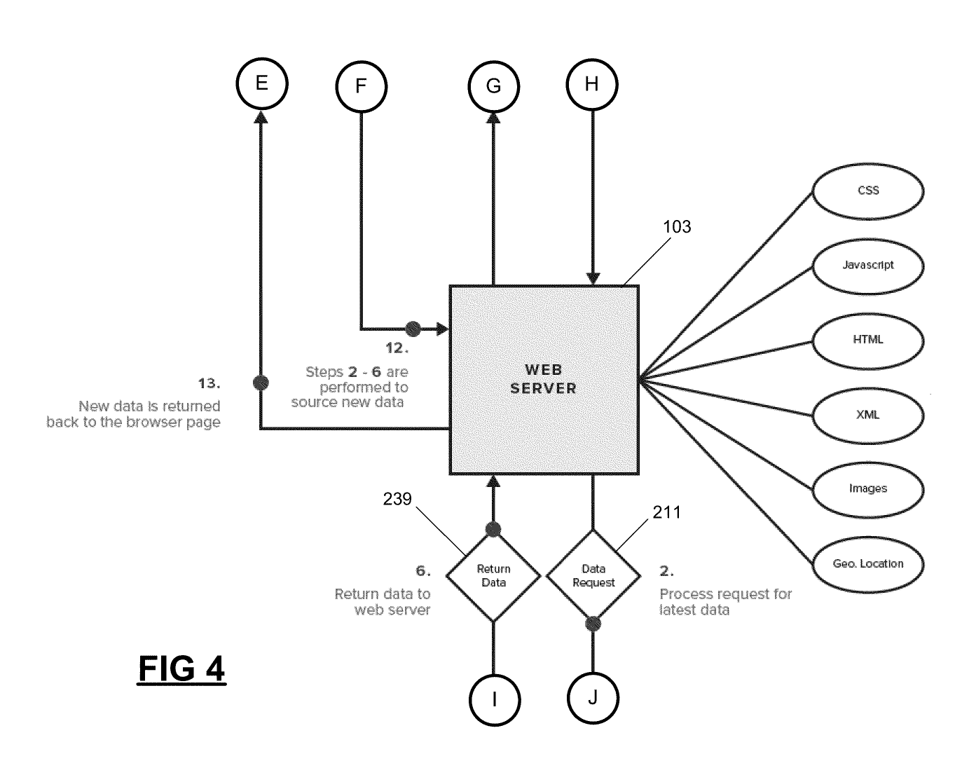

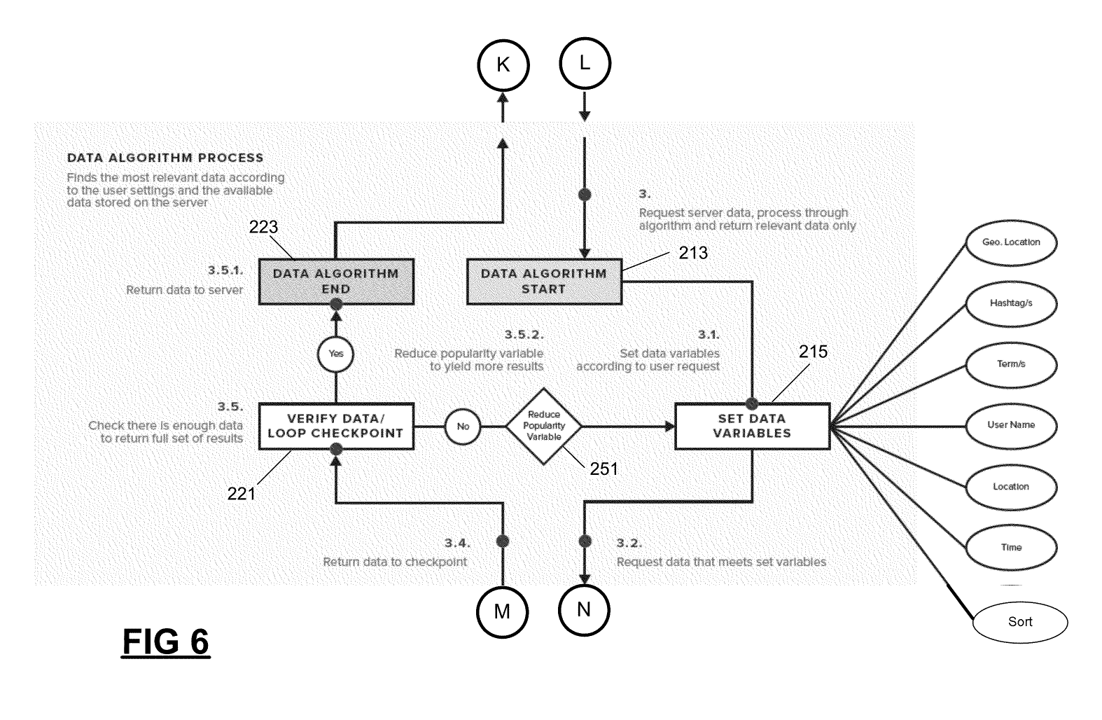

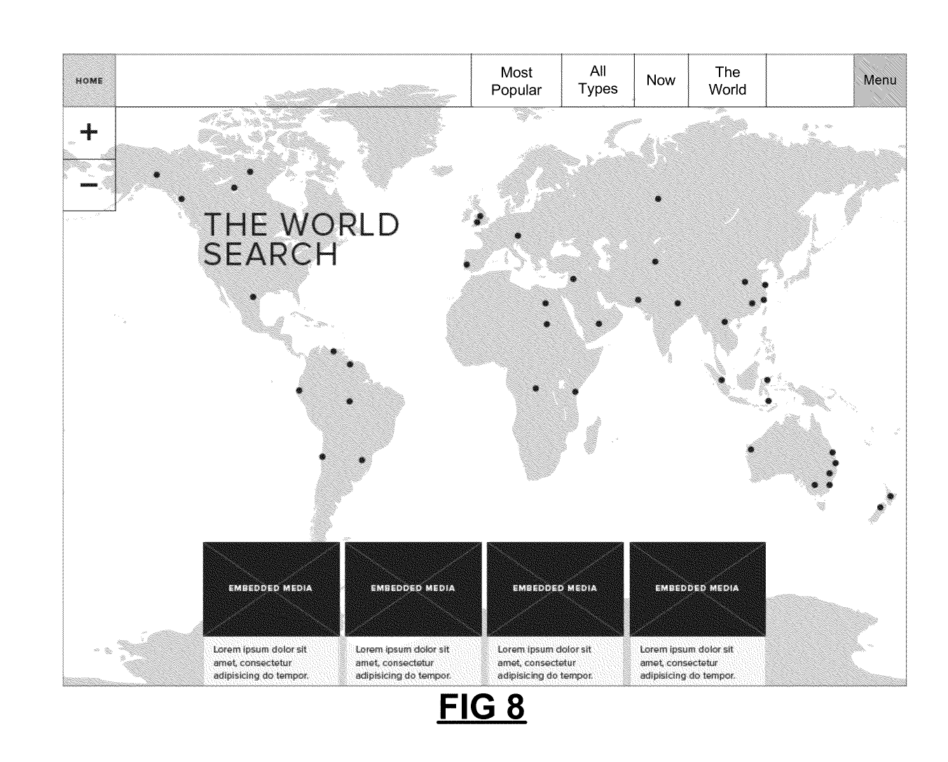

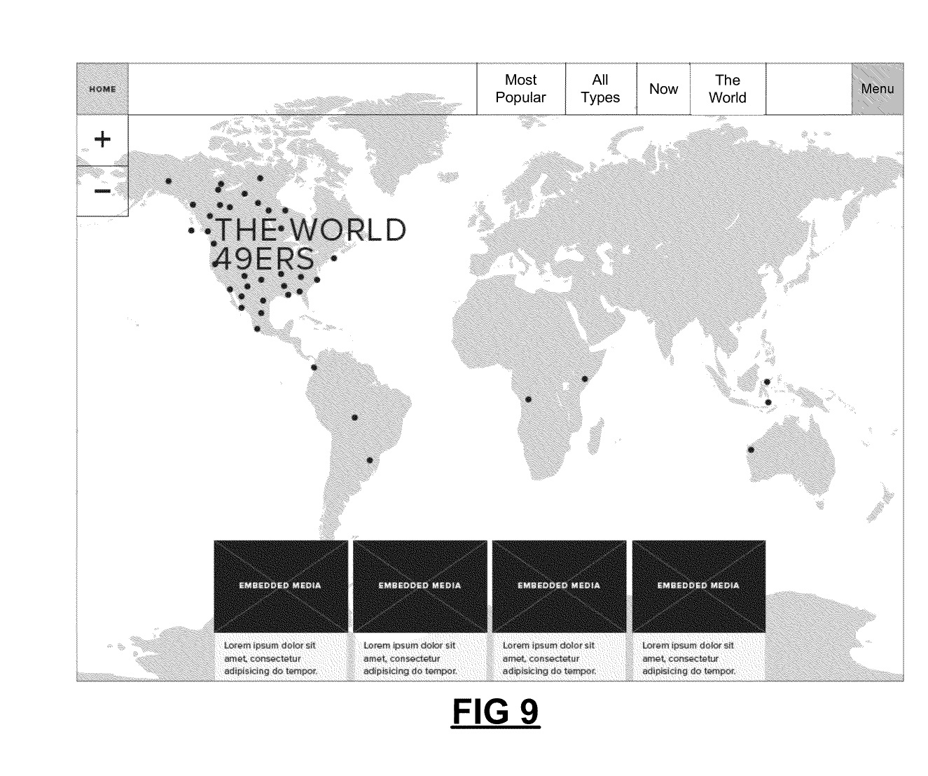

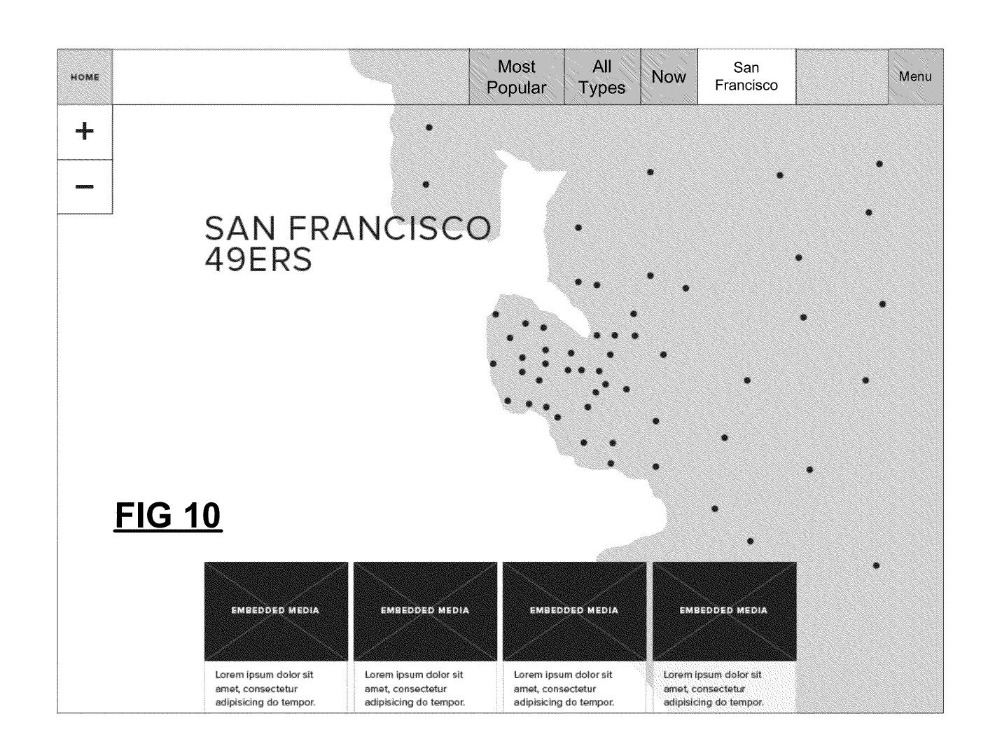

The webserver then returns data requests corresponding to search queries entered by the client into the webpage displayed on the client computational device 105. These data requests are processed by the webserver 103 in boxes 205, 207, 209. Data request 211 (FIG. 4) is then processed at boxes 213, 215 by the webserver 103 and then a data request (box 217 FIG. 7) is sent to database server 109 which interrogates database 113. The results from the database interrogation are processed via the Step 3 Pseudo Code (boxes 219, FIG. 8; boxes 221, 223, FIG. 6.

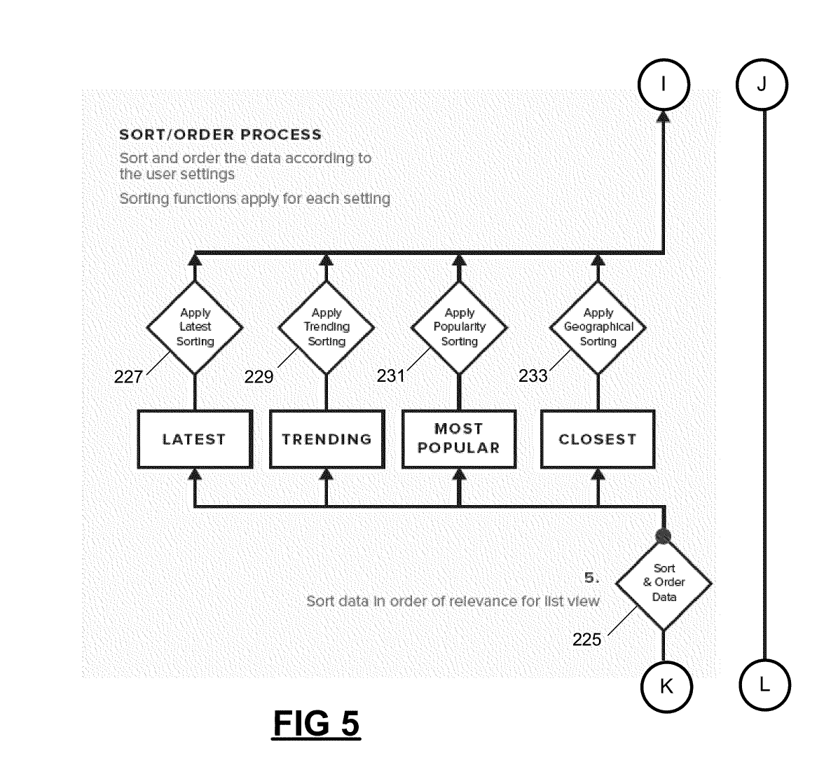

The next step is as set out in the Step 4 Pseudo Code and involves the data sorting and ordering process of boxes 227 to 233 of FIG. 5. The sorted and ordered search result data is then returned, via boxes 239 (FIG. 4), 241, 243 (FIG. 3) to the browser viewable webpage (FIG. 2) for display on client device 105.

Step 5 of Pseudo Code involves the return of the sorted and ordered data via box 245 (FIG. 3).

Step 6 of the Pseudo Code is concerned with listening (box 247, FIG. 7) for new data on the database server that satisfies the search criteria at predetermined time intervals.

Step 7 of the Pseudo Code involves the database server pushing (box 249, FIG. 7) relevant new data to the webserver for display on the webpage.

Examples of Uses of the Method

Some examples of the practical uses of the system will now be explained with user inputs, as set out in Table 1, noted in the following format:

SEARCH: “Search Term” (Sort|Content Type|Time|Location)

### Example 1

### Use Social Media Content and Geo Tagging to Discover Uncensored, Live, Real-Time Information Throughout the World.

Search for the latest content specific to a subject and location as follows:

SEARCH “49ers” (Latest|All Types|Past 10 Minutes|San Francisco)

These search terms command the system to search over all types of media for the term “49ers” that have occurred in the last 10 minutes with geo tags for San Francisco.

The first step in processing the search query comprises calling the Step 1 Pseudo Code as follows: On Initial Page Request—onLoad

Set initial refinements to pull most popular results. Server receives call for dataAlgorithm function to request relevant data.

SET geoLocation to be worldwide

SET hashTag to null

SET Term to null

SET userName to nujll

SET Time to Latest (x minutes)

SET Sort to mostPopular

CAll dataAlgorithm

In response to this initialization an initial page loads on the client device 105 as shown in FIG. 8. This webpage depicts what happens when the page initially loads. The system finds the most popular social media content around the world at that particular time and plots it on the map according to its geographical location.

The search term is then refined by the user to “49ers” and the Step 2 Pseudo Code is executed as follows:

Step 2 Pseudo Code

On refinement being set—dataRequest

Receive refinement inputs from the user

Call for dataAlgorithm function to request relevant data

```
IF Term is defined by the user THEN
  SET Term to “49ers”
  CALL dataAlgorithm
END IF
```

Step 3 Pseudo Code

Data is requested from the server—dataAlgorithm

User refinements are set for data algorithm function

Server receives call for data

Data is run through checkpoint to ensure there are enough results

If insufficient results are returned the time variable is decremented and run through the algorithm again

Once enough results are returned, the data is stored for sorting function

```
SET Term to “49ers”
// Call data from the server
CALL Data
//If the data algorithm returns less than a full set of results
IF dataResults is < Full THEN
  //Reduce Popularity variable using Time variable
  IF Time > 0 THEN
  DECREMENT Time
  CALL Data
  END IF
END IF
STORE Data in dataResults
END dataAlgorithm
```

Step 4 Pseudo Code

Data is sorted for site viewing—dataSort

Server receives call for data

geoLocation is read from social media content and geoPosition is calculated to place the content on the map. Sorting variables are read from the website along with data to calculate the order position of the content. The content is sorted, ordered and returned to the website.

CALL Data from the server

READ geoLocation from Social Media content

FOR each Data Set (individual Social Media content)

COMPUTE geoPosition
// geoPosition = geoLocation at map screen view
STORE geoPosition in Result (Data Set)
End FOR

READ Sort, shareCount, viewCount, friendCount and Time variables from Social

Media content

```
IF Sort = mostPopular THEN
  FOR each Data Set (individual Social Media content)
  COMPUTE orderPosition
  // orderPosition = ((shareCount + viewCount) / friendCount ) / Time
  STORE orderPosition in Result (Data Set)
  End FOR
  END IF
```

STEP 5. Pseudo Code

Data is returned to browser viewable web page—

dataReturn

Server pushes data to web page

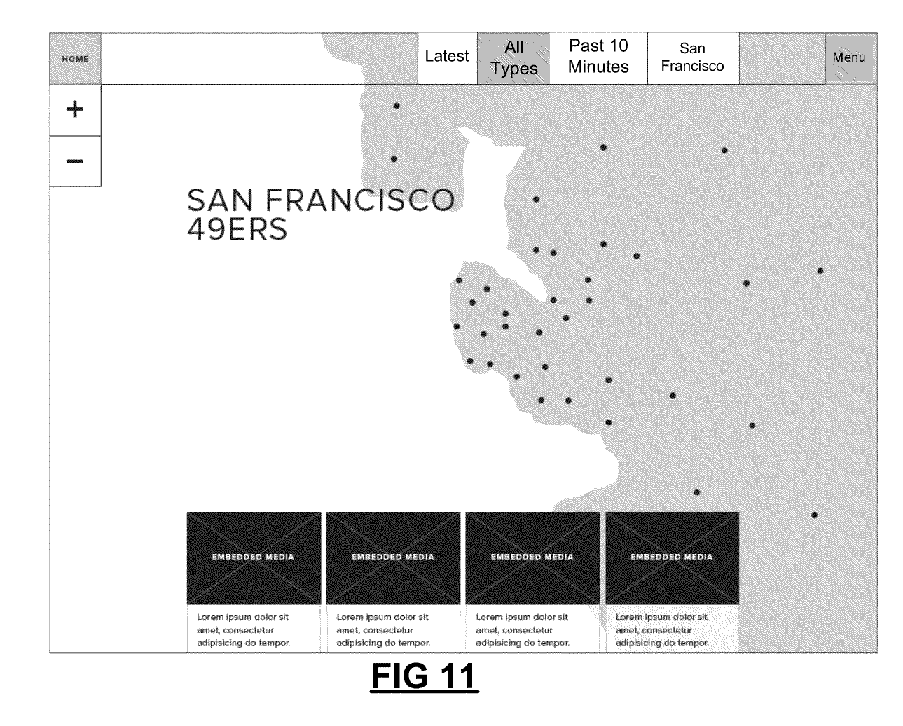

At the conclusion of Step 5. Pseudo Code the webpage shown in FIG. 11 is displayed on the client device 105. This webpage shows where the greatest number of Tweets containing the search term “49ers” have originated from, i.e. North America.

The next refinement is that the geolocation variable is set to “San Francisco”.

Location set to “San Francisco”

(DATAREQUEST, DATAALGORITHM, DATASORT & DATARETURN PROCESS)

STEP 2. Pseudo Code

On refinement being set—dataRequest. Receive refinement inputs from the user. Call for dataAlgorithm function to request relevant data.

```
IF Location is defined by the user THEN
  SET Location to “San Francisco”
  CALL dataAlgorithm
  END IF
```

STEP 3. Pseudo Code

Data is requested from the server—dataAlgorithm. User refinements are set for dataAlgorithm function. Server receives call for data. Data is run through checkpoint to ensure there are enough results. If not enough results are returned, the time variable is decremented and run through the algorithm again. Once enough results are returned, the data is stored for the sorting function.

```
SET Location to “San Franciso”
// Call data from the server
CALL Data
// If the data algorithm returns less than a full set of results
IF dataResults is < Full THEN
  // Reduce Popularity variable using Time variable
  IF Time > 0 THEN
  DECREMENT Time
  CALL Data
  END IF
  END IF
  STORE Data in dataResults
  END dataAlgorithm
```

STEP 4. Pseudo Code

Data is sorted for site viewing—dataSort

Server receives call for data

geoLocation is read from social media content and geoPosition is

calculated to place content on the map

Sorting variables are read from website along with data to calculate

the order position of the content

Content is sorted, ordered and returned to website

CALL Data from the server

READ geoLocation from Social Media content

FOR each Data Set (individual Social Media content)

COMPUTE geoPosition
// geoPosition = geoLocation at map screen view
STORE geoPosition in Result (Data Set)
End FOR

READ Sort, shareCount, viewCount, friendCount and Time variables

from Social Media content

```
IF Sort = mostPopular THEN
  FOR each Data Set (individual Social Media content)
  COMPUTE orderPosition
  // orderPosition = ((shareCount + viewCount) / friendCount ) / Time
  STORE orderPosition in Result (Data Set)
  End FOR
  END IF
```

STEP 5. Pseudo Code.

Data is returned to browser viewable web page

dataReturn

Server pushes data to web page

At the conclusion of the STEP 5. Pseudo Code the webpage of FIG. 11 is displayed.

The next stage is that the search is refined to only reveal those search results that have a time tag of less than ten minutes ago. It will be realised that this allows the searcher to find very up to date results.

Time refinement set to “Past 10 Minutes”, Sort set to “Latest” (DATAREQUEST, DATAALGORITHM, DATASORT & DATARETURN PROCESS)

STEP 2. Pseudo Code

On refinement being set—dataRequest

Receive refinement inputs from the user

Call for dataAlgorithm function to request relevant data

```
IF Time is defined by the user THEN
  SET Time to “Past 10 Minutes”
  CALL dataAlgorithm
  END IF
```

STEP 3. Pseudo Code

Data is requested from the server—dataAlgorithm

User refinements are set for dataAlgorithm function. Server receives call for data. Data is run through checkpoint to ensure there are enough results.

If not enough results are returned, the time variable is decremented and run through the algorithm again. Once enough results are returned, the data is stored for sorting function.

```
SET Time to “Past 10 Minutes”
// Call data from the server
CALL Data
// If the data algorithm returns less than a full set of results
IF dataResults is < Full THEN
  // Reduce Popularity variable using Time variable
  IF Time > 0 THEN
    DECREMENT Time
    CALL Data
    END IF
    END IF
STORE Data in dataResults
END dataAlgorithm
```

STEP 4.

Data is sorted for site viewing—dataSort

Server receives call for data. geoLocation is read from social media content and geoPosition is calculated to place content on the map. Sorting variables are read from website along with data to calculate the order position of the content. Content is sorted, ordered and returned to website.

```
CALL Data from the server
READ geoLocation from Social Media content
FOR each Data Set (individual Social Media content)
  COMPUTE geoPosition
  // geoPosition = geoLocation at map screen view
  STORE geoPosition in Result (Data Set)
End FOR
READ Sort, shareCount, viewCount, friendCount and Time variables
from Social Media content
IF Sort = Latest THEN
  FOR each Data Set (individual Social Media content)
  COMPUTE orderPosition
  // orderPosition = Time latest
  STORE orderPosition in Result (Data Set)
End FOR
END IF
```

STEP 5. Pseudo Code

Data is returned to browser viewable web page—dataReturn

Server pushes data to web page

At the end of the STEP 5. Pseudo code the webpage of FIG. 11 is displayed which shows the results of a search for results including the term “49ers” originating from the San Francisco area in the last ten minutes.

Scroll activates to list view of results (DATALISTEN PROCESS RUNS IN BACKGROUND AS USER BROWSES)

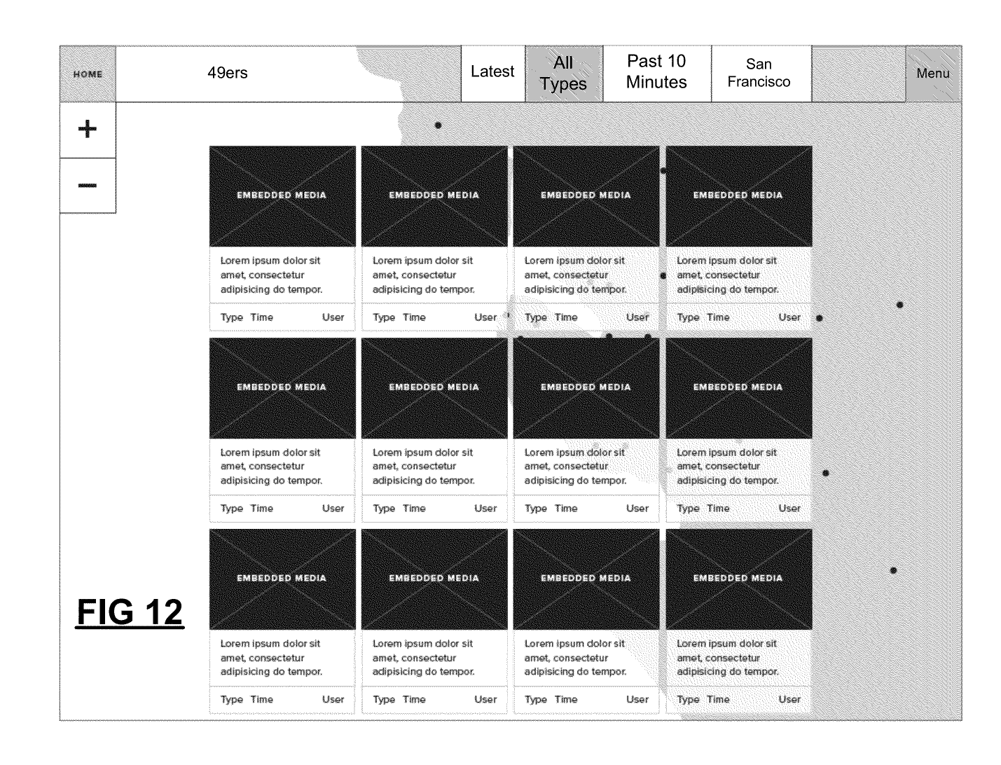

FIG. 12 is a list view of the results presented in the screen of FIG. 11. The user may click on one of the list entries to be taken to detailed information about the entry.

As the list view is displayed the server continues to listen for new data that meets the search criteria according to the STEP 6. Pseudo Code as follows:

STEP 6. Pseudo Code

Listen for new data—dataListen

Server listens for new data

```
IF timeElapsed = timeInterval THEN
  CALL dataAlgorithm function
  CALL dataSort function
  CALL dataPush function
  END IF
```

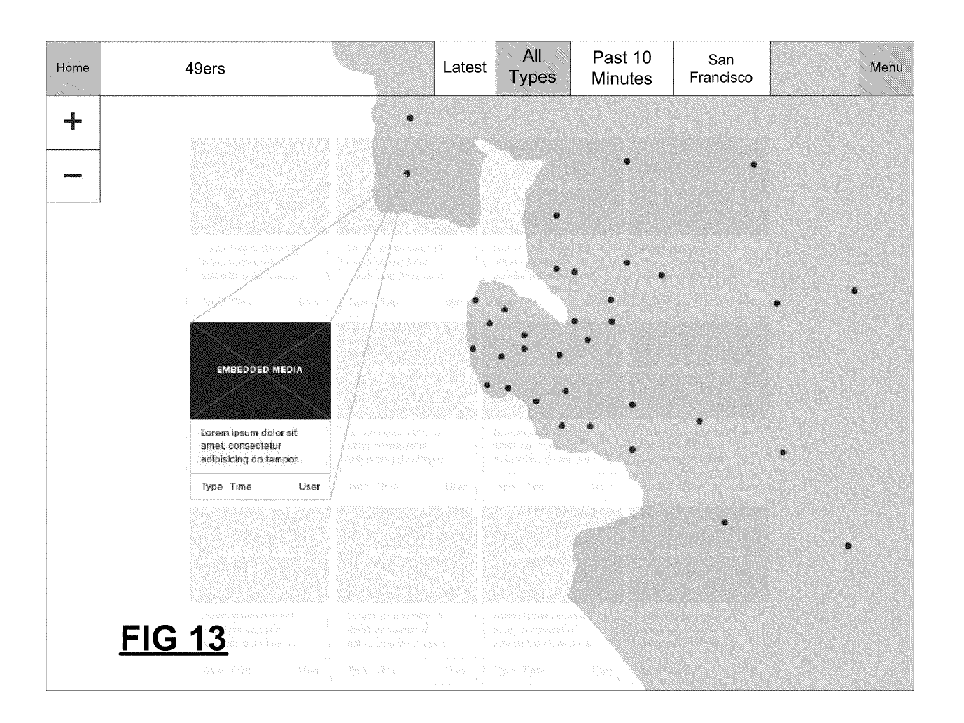

FIG. 13 shows the screen that is presented when a single item of the search results is selected by the user to pinpoint a map location

The DATALISTEN process continues to run in the background as the user browses the results so that any relevant new search results are presented. This is done using the STEP 6. Pseudo Code as follows:

STEP 6. Pseudo Code

Listen for new data—dataListen

Server listens for new data

```
IF timeElapsed = timeInterval THEN
  CALL dataAlgorithm function
  CALL dataSort function
  CALL dataPush function
  END IF
```

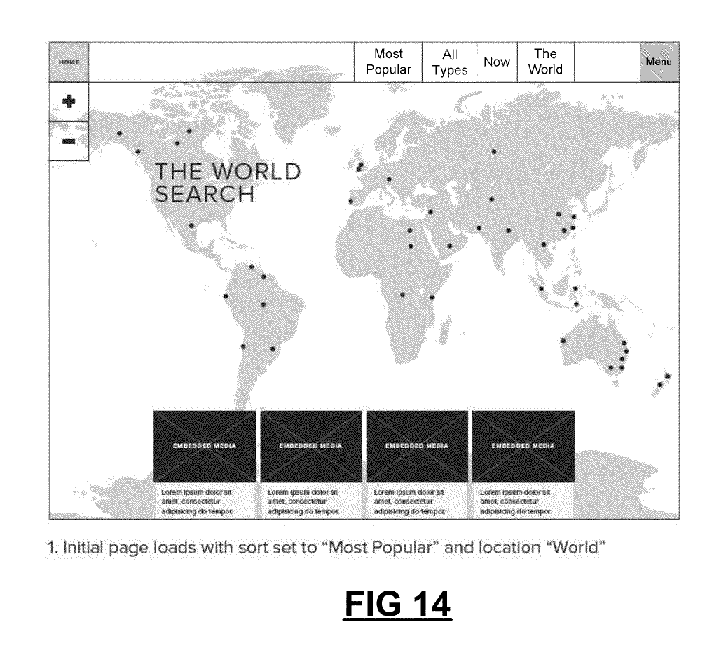

Referring now to FIGS. 14 to 17, a trending search capability of the system will be described.

In FIG. 14, upon the browser of the remote device 105 establishing data communication with webserver 103, an initial page is loaded with the sort variable set to “Most Popular” and the location variable set to “World”. The user of the remote device 105 can choose to select a “Trending” button 302 from the drop down menu 300.

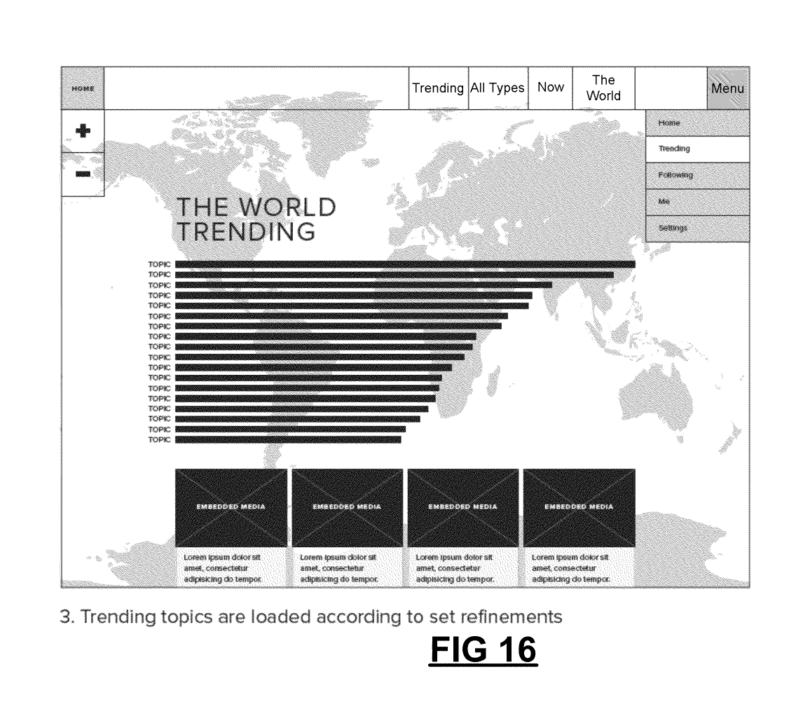

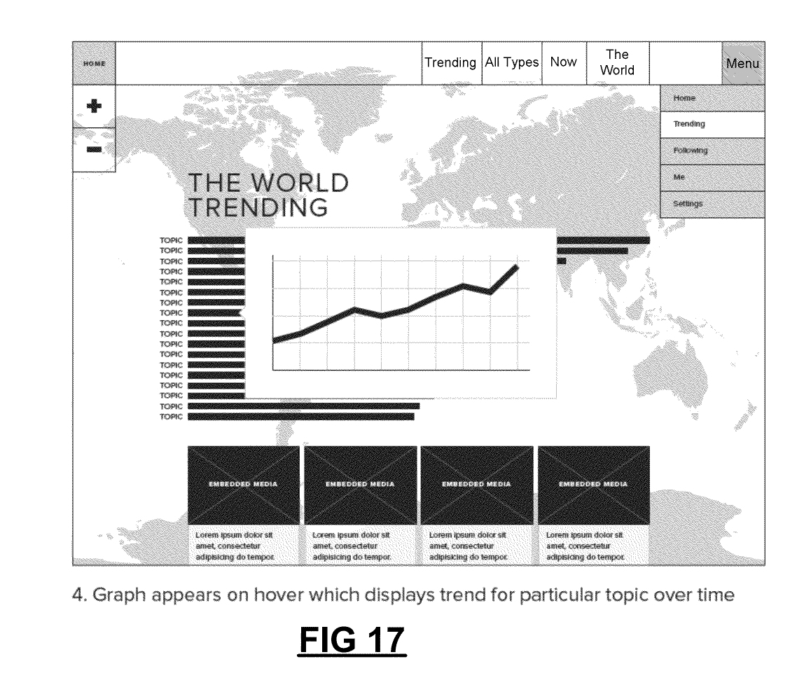

In response a trending topics screen is presented as shown in FIG. 16. This screen includes a graph that shows a vertical list of topics with a histogram indicating which topics are occurring most frequently. Upon the user hovering a cursor over a topic a graph is presented for that topic as shown in FIG. 17 which displays the trend for a particular topic over time.

Embodiments of the present invention use social media to consolidate vast amounts of information about a very large proportion of the population on most topics at every time and every location. By combining the use of the data, the system presents clients with a search engine that taps into a mass consciousness (i.e. the universe of social media posts) on a global scale. In doing so, it is able to sort through huge amounts of data and deliver results in a useable format which can be filtered and refined into useful, relevant and understandable content.

To reiterate, a method according to a preferred embodiment of the present invention involves aggregating post text, information about the type of content that has been posted, the post's creation time (time stamp), geographical origin (geo tag) and the username and storing it in a database. In order to search the content that has been stored a web-server prompts clients for their search terms which it then parses. The webserver is programmed to identify portions of the search terms as corresponding to locations, hashtags or general search keywords. The method then involves interrogating the database to return relevant results from the vast array of social media content. The results are initially presented back to clients as links comprising markers on a map described on the screen of the client's device. The client can scroll the map view in order to also see the results in a list format. The client can then refine the results according to a number of filters such as content type, the timeframe in which they were posted and their geographic location. The client can also sort the results in order of “latest”, “trending”, “most popular” and “geographical proximity”. If a list item is selected then the other results will fade out and the selected list item's geographical location is presented pinpointed on the map displayed on the user's client device.

The detailed description contained herein is represented partly in terms of processes and symbolic, e.g. diagrammatic, representations of operations and data structures implemented by a conventional computer and/or wired or wireless network. The processes and operations performed by the computer include the manipulation of signals by a processor (e.g. processor 3 and/or GPU 8 of computer system 1 of FIG. 3) and the maintenance of these signals within data packets and data structures (e.g. octrees) resident in one or more media within memory storage devices. Generally, a “data structure” is an organizational scheme applied to data or an object so that specific operations can be performed upon that data or modules of data so that specific relationships are established between organized parts of the data structure.

A “data packet” is type of data structure having one or more related fields, which are collectively defined as a unit of information transmitted from one device or program module to another. Thus, the symbolic representations of operations are the means used by those skilled in the art of computer programming and computer construction to most effectively convey teachings and discoveries to others skilled in the art.

For the purpose of this discussion, a process is generally conceived to be a sequence of computer-executed steps leading to a desired result. These steps generally require physical manipulations of physical quantities. Usually, though not necessarily, these quantities take the form of electrical, magnetic, or optical signals capable of being stored, transferred, combined, compared, or otherwise manipulated. It is conventional for those skilled in the art to refer to representations of these signals as bits, bytes, words, information, data, packets, nodes, numbers, points, entries, objects, images, files or the like. It should be kept in mind, however, that these and similar terms are associated with appropriate physical quantities for computer operations, and that these terms are merely conventional labels applied to physical quantities that exist within and during operation of the computer.

It should be understood that manipulations within the computer are often referred to in terms such as issuing, sending, altering, adding, disabling, determining, comparing, reporting, rendering, displaying, projecting and the like, which may sometimes be associated with manual operations performed by a human operator. The operations described herein are machine operations performed in conjunction with various inputs provided by a human operator or user that interacts with the computer.

Hardware

It should be understood that the programs, processes, methods, etc. described herein are not related or limited to any particular computer or apparatus, nor are they related or limited to any particular communication architecture. For example, a general purpose computer system has been illustrated in FIG. 3 which is shown as having a desktop computer form however it will be understood that laptops, game consoles, mobile phones and dedicated computational apparatus, e.g. for rendering medical and architectural images are all encompassed. Various types of general purpose machines, sensors, transmitters, receivers, transceivers, and network physical layers may be used with any program modules and any other aspects of the invention constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory, such as read-only memory.

Program

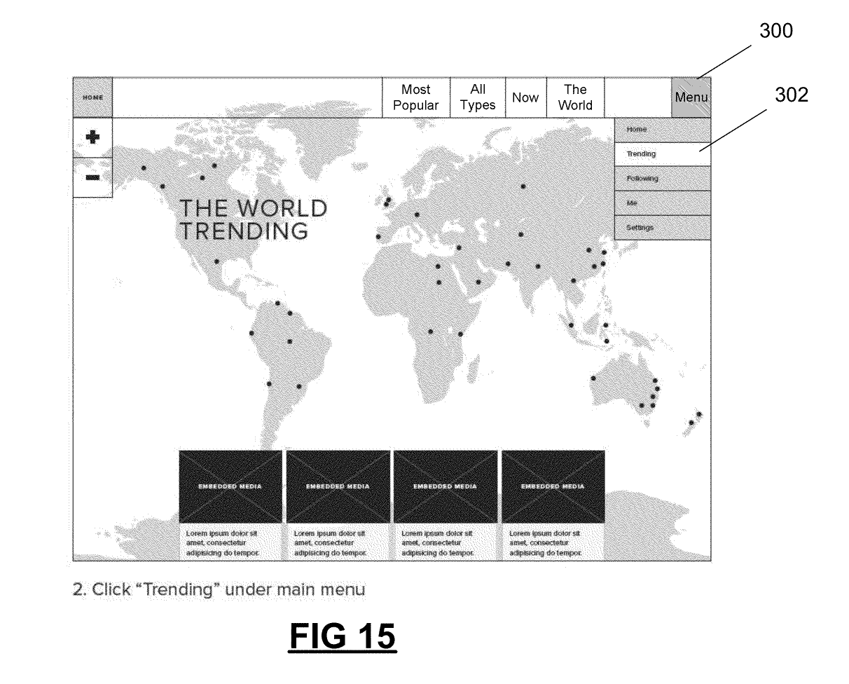

In the preferred embodiment where any steps of the present invention (e.g. the steps described with reference to FIGS. 14 and 15) are embodied in machine-executable instructions, the instructions can be used to cause a general-purpose or special-purpose processor which is programmed with the instructions to perform the steps of the present invention. Alternatively, the steps of the present invention might be performed by specific hardware components that contain hardwired logic for performing the steps, or by any combination of programmed computer components and custom hardware components.

The foregoing system may be conveniently implemented in a program or program module(s) that is based upon the diagrams and descriptions in this specification. No particular programming language has been required for carrying out the various procedures described above because it is considered that the operations, steps, and procedures described above and illustrated in the accompanying drawings are sufficiently disclosed to permit one of ordinary skill in the art to practice the present invention.

Moreover, there are many computers, computer languages, and operating systems which may be used in practicing the present invention and therefore no detailed computer program could be provided which would be applicable to all of these many different systems. Each user of a particular computer will be aware of the language and tools which are most useful for that user's needs and purposes.

The invention thus can be implemented by programmers of ordinary skill in the art without undue experimentation after understanding the description herein.

Product

The present invention is composed of hardware and computer program products (e.g. product 16 of FIG. 3) which may include a machine-readable medium, e.g. the disk 15 of FIG. 3, having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, or other type of media/machine-readable medium suitable for storing electronic instructions. Moreover, the software portion of the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection) such as network adaptor 13 of FIG. 3.

Components

The major components (also interchangeably called aspects, subsystems, modules, functions, services) of the system and method of the invention, and examples of advantages they provide, are described herein with reference to the figures. For figures including process/means blocks, each block, separately or in combination, is alternatively computer implemented, computer assisted, and/or human implemented. Computer implementation optionally includes one or more conventional general purpose computers having a processor, memory, storage, input devices, output devices and/or conventional networking devices, protocols, and/or conventional client-server hardware and software. Where any block or combination of blocks is computer implemented, it is done optionally by conventional means, whereby one skilled in the art of computer implementation could utilize conventional algorithms, components, and devices to implement the requirements and design of the invention provided herein. However, the invention also includes any new, unconventional implementation means.

Other Implementations

Other embodiments of the present invention and its individual components will become readily apparent to those skilled in the art from the foregoing detailed description. As will be realized, the invention is capable of other and different embodiments, and its several details are capable of modifications in various obvious respects, all without departing from the spirit and the scope of the present invention. Accordingly, the drawings and detailed description are to be regarded as illustrative in nature and not as restrictive. It is therefore not intended that the invention be limited except as indicated by the appended claims.

In compliance with the statute, the invention has been described in language more or less specific to structural or methodical features. The term “comprises” and its variations, such as “comprising” and “comprised of” is used throughout in an inclusive sense and not to the exclusion of any additional features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

Throughout the specification and claims (if present), unless the context requires otherwise, the term “substantially” or “about” will be understood to not be limited to the value for the range qualified by the terms.

Any embodiment of the invention is meant to be illustrative only and is not meant to be limiting to the invention. Therefore, it should be appreciated that various other changes and modifications can be made to any embodiment described without departing from the spirit and scope of the invention.

I claim:

1. A method for returning search results to a client computational device including the steps of:
storing the content of social media posts in a database wherein the social media posts are searchable by at least geotags, timestamps and post text;
processing a search query from a remote client by parsing the search query for at least search keywords, a specified geographical location and a specified time frame;
operating a database server in communication with the database to return search results therefrom corresponding to the search query; and
serving the search results to a browser running on the client computational device.

2. The method according to claim 1, wherein search results are presented as points on a map wherein the points are presented at the specified geographical location.

3. The method according to claim 1, including reducing a popularity variable in the event that the number of returned search results does not comprise a full set of results.

4. The method according to claim 1, wherein the search results are presented as lists of results.

5. The method according to claim 1 including presenting the user with a number of options for sorting search results.

6. The method according to claim 1 including presenting the user with one or more options for ordering search results.

7. The method according to claim 1, including the step of presenting the search results includes presenting the search results to graphically indicate the latest search results.

8. The method according to claim 1, including continuously updating the store of social media posts and presenting updated search results to the remote client as new posts meeting the remote client's search query are encountered.

9. The method according to claim 1 including presenting the remote client with options to refine the search query according to a number of filters.

10. The method according to claim 9, wherein the filters may include one or more of:
content type, timeframe in which posts were created; or geographic location.

11. The method according to claim 2, wherein search results are presented as points on a map wherein the points are presented at the specified geographical location.

12. The method according to claim 11, including reducing a popularity variable in the event that the number of returned search results does not comprise a full set of results.

13. The method according to claim 3, wherein the search results are presented as lists of results.

14. The method according to claim 13 including presenting the user with a number of options for sorting search results.

15. The method according to claim 14, including presenting the user with one or more options for ordering search results.

16. The method according to claim 15, wherein the step of presenting the search results includes presenting the search results to graphically indicate the latest search results.

17. The method according to claim 12, including continuously updating the store of social media posts and presenting updated search results to the remote client as new posts meeting the remote client's search query are encountered.

18. The method according claim 17, including presenting the remote client with options to refine the search query according to a number of filters.

19. The method according to claim 18, wherein the filters may include one or more of:
content type,
timeframe in which posts were created; or
geographic location.
